(19) United States
(12) Patent Application Publication
(10) Pub. No.: US 2023/0311865 A1
(43) Pub. Date: Oct. 5, 2023

(54) CONTROL DEVICE

(71) Applicant: HONDA MOTOR CO., LTD., Tokyo (JP)

(72) Inventors: Yuichi KOMORI, Saitama (JP); Shohei NOAI, Saitama (JP)

(73) Assignee: HONDA MOTOR CO., LTD., Tokyo (JP)

(21) Appl. No.: 18/128,074

(22) Filed: Mar. 29, 2023

(30) Foreign Application Priority Data
Mar. 30, 2022 (JP) 2022-057684

(51) Int. Cl. B60W 30/095; B60W 10/18; B60W 10/20

(52) U.S. Cl. CPC B60W 30/0956; B60W 10/18; B60W 10/20; B60W 2554/4041; B60W 2710/18; B60W 2710/202

(57) ABSTRACT

A vehicle control device includes processing circuitry configured to: detect a predetermined travel path boundary and a travel path region for the vehicle to travel partitioned by the travel path boundary, based on surrounding information of the vehicle; and generate travel path information indicating positions of the detected travel path boundary and the travel path region based on a detection result of the detection unit. When the moving body is detected around the vehicle based on the surrounding information, the processing circuitry refers to the travel path information, and determines whether the moving body is positioned in a target travel path region in which the vehicle travels, and executes the collision prevention control that prevents collision between the vehicle and a moving body based on determination that the moving body is positioned in the target travel path region.

### CROSS-REFERENCE TO RELATED APPLICATIONS

This application is based on and claims priority under 35 USC 119 from Japanese Patent Application No. 2022-057684 filed on Mar. 30, 2022, the entire content of which is incorporated herein by reference.

### TECHNICAL FIELD

The present invention relates to a control device that controls a vehicle.

### BACKGROUND ART

In recent years, efforts are made to provide access to a sustainable transportation system that considers vulnerable traffic participants. As one of these efforts, research and development on driving assistance techniques and automatic driving techniques for vehicles such as automobiles are conducted to further improve safety and convenience of traffic. As an example of the driving assistance techniques, cameras and sensors installed in the vehicle monitor around of the vehicle, and when an object (such as other vehicles) that may collide with the vehicle is detected around of the vehicle, collision prevention control for preventing collision with the object is performed.

JP2016-88158A below describes a technique in which in a surrounding monitoring device including an imaging unit that captures an image of a periphery of a host vehicle, a display unit that displays the image captured by the imaging unit, a detection unit that detects an object to be noted in the image captured by the imaging unit, and a warning display control unit that superimposes and displays a warning display on the object or in the periphery of the object in the image based on the detection by the detection unit, the warning display control unit continues to display a warning display displayed at a first timing even if a warning display is displayed at a second timing after the first timing.

In the related art, collision prevention control can be executed simply based on the matter that a moving body such as the other vehicle is detected around the host vehicle. For this reason, for example, the collision prevention control may be executed even when there is a predetermined travel path boundary such as a fence between the moving body and the host vehicle and it is assumed that a possibility of collision between the moving body and the host vehicle is actually low. In addition, the driver may feel annoyed by such excessive collision prevention control.

An aspect of the present disclosure relates to provide a vehicle control device capable of reducing excessive collision prevention control.

### SUMMARY OF INVENTION

According to an aspect of the present disclosure, there is provided a vehicle control device for controlling a vehicle equipped with an external sensor that acquires surrounding information of the vehicle. The control device includes processing circuitry configured to: detect a predetermined travel path boundary and a travel path region for the vehicle to travel partitioned by the travel path boundary, based on the surrounding information acquired by the external sensor; and generate travel path information indicating positions of the detected travel path boundary and the travel path region based on a detection result of the detection unit, and capable of executing collision prevention control that prevents collision between the vehicle and a moving body when the moving body is detected around the vehicle based on the surrounding information. When the moving body is detected, the processing circuitry refers to the travel path information, and determines whether the moving body is positioned in a target travel path region in which the vehicle travels, and executes the collision prevention control based on determination that the moving body is positioned in the target travel path region.

### BRIEF DESCRIPTION OF DRAWINGS

FIG. 1 is a block diagram showing a schematic configuration of a vehicle according to one embodiment;

FIG. 2 is a flow chart showing an example of travel path information generation executed by a control device according to the embodiment;

FIG. 3 is a diagram showing an operation example of a vehicle that can be implemented by the travel path information generation shown in FIG. 2;

FIG. 4 is a flow chart showing an example of collision prevention control executed by a control device according to the embodiment;

FIG. 5 is a diagram showing an operation example of the vehicle that can be implemented by the collision prevention control shown in FIG. 4; and

FIG. 6 is a diagram showing a specific example of the collision prevention control.

### DESCRIPTION OF EMBODIMENTS

An embodiment of a control device according to the present invention will be described below with reference to the drawings. Note that in the following description, the same or similar elements are denoted by the same or similar reference signs, and the description thereof may be omitted or simplified as appropriate.

### Vehicle

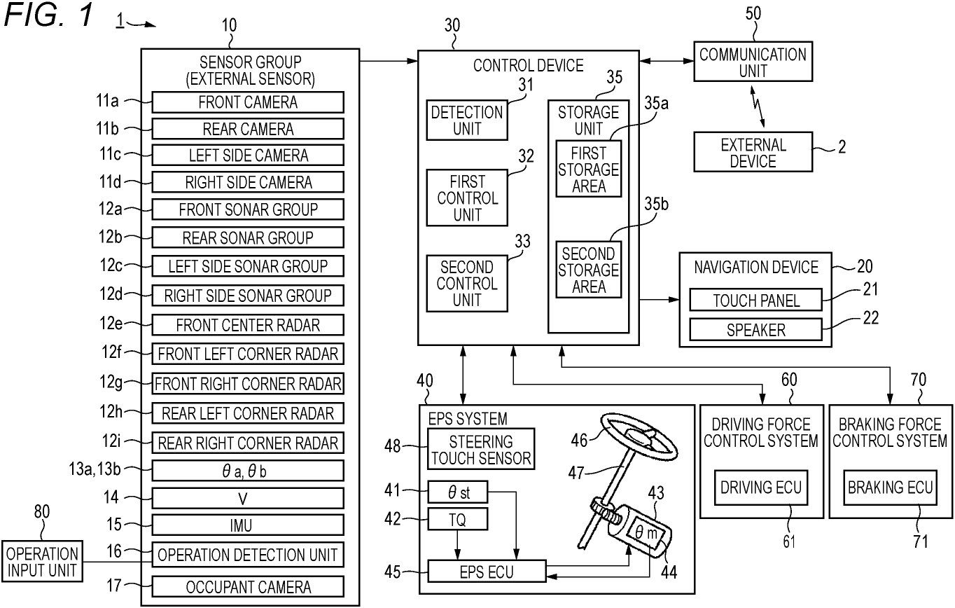

A vehicle 1 (hereinafter also referred to as “host vehicle”) according to the present embodiment shown in FIG. 1 is an automobile that includes a drive source, and wheels including drive wheels driven by power of the drive source and steerable steering wheels (both not shown). For example, the vehicle 1 is a four-wheeled automobile including a pair of left and right front wheels and a pair of left and right rear wheels. The drive source of the vehicle 1 may be an electric motor, an internal combustion engine such as a gasoline engine or a diesel engine, or a combination of the electric motor and the internal combustion engine. The drive source of the vehicle 1 may drive the pair of left and right front wheels, the pair of left and right rear wheels, or the four wheels including the pair of left and right front wheels and the pair of left and right rear wheels. The front wheels or the rear wheels may be steering wheels that are steerable, or the front wheels and the rear wheels may both be steering wheels that are steerable.

As shown in FIG. 1, the vehicle 1 includes a sensor group 10, a navigation device 20, a control device 30 which is an example of a control device according to the present invention, an electric power steering system (EPS system) 40, a communication unit 50, a driving force control system 60, a braking force control system 70, and an operation input unit 80.

The sensor group 10 acquires various detection values related to the vehicle 1 or surrounding of the vehicle 1. The detection values acquired by the sensor group 10 are sent to the control device 30 and used for controlling the vehicle 1 by the control device 30. The sensor group 10 includes, for example, a front camera 11a, a rear camera 11b, a left side camera 11c, a right side camera 11d, a front sonar group 12a, a rear sonar group 12b, a left side sonar group 12c, a right side sonar group 12d, a front center radar 12e, a front left corner radar 12f, a front right corner radar 12g, a rear left corner radar 12h, and a rear right corner radar 12i. These cameras, sonar groups, radars, LIDARs, and the like can function as external sensors that acquire surrounding information of the vehicle 1.

The front camera 11a, the rear camera 11b, the left side camera 11c, and the right side camera 11d output image data of surrounding images acquired by capturing the surrounding of the vehicle 1 to the control device 30. The surrounding images captured by the front camera 11a, the rear camera 11b, the left side camera 11c, and the right side camera 11d are also called a front image, a rear image, a left side image, and a right side image, respectively. An image formed by the left side image and the right side image is also referred to as a side image.

The front sonar group 12a, the rear sonar group 12b, the left side sonar group 12c, and the right side sonar group 12d emit sound waves to the surrounding of the vehicle 1 and receive reflected sounds from other objects. The front sonar group 12a includes, for example, four sonars. The sonars that constitute the front sonar group 12a are provided at an obliquely left front side, a left front side, a right front side, and an obliquely right front side of the vehicle 1. The rear sonar group 12b includes, for example, four sonars. The sonars that constitute the rear sonar group 12b are provided at an obliquely left rear side, a left rear side, a right rear side, and an obliquely right rear side of the vehicle 1. The left side sonar group 12c includes, for example, two sonars. The sonars that constitute the left side sonar group 12c are provided on a front side of a left side of the vehicle 1 and a rear side of the left side of the vehicle 1. The right side sonar group 12d includes, for example, two sonars. The sonars that constitute the right side sonar group 12d are provided on a front side of a right side of the vehicle 1 and a rear side of the right side of the vehicle 1.

The front center radar 12e, the front left corner radar 12f, the front right corner radar 12g, the rear left corner radar 12h, and the rear right corner radar 12i emits radar waves to the surrounding of the vehicle 1 and receives radar waves reflected by other objects. More specifically, the front center radar 12e emits radar waves to a front side of the vehicle 1 and receives radar waves reflected by objects present in the front side of the vehicle 1. The front left corner radar 12f emits radar waves to an obliquely left front side of the vehicle 1 and receives radar waves reflected by objects present in the obliquely left front side of the vehicle 1. The front right corner radar 12g emits radar waves to an obliquely right front side of the vehicle 1 and receives radar waves reflected by objects present in the obliquely right front side of the vehicle 1. The rear left corner radar 12h emits radar waves to an obliquely left rear side of the vehicle 1 and receives radar waves reflected by objects present in the obliquely left rear side of the vehicle 1. The rear right corner radar 12i emits radar waves to an obliquely right rear side of the vehicle 1 and receives radar waves reflected by objects present in the obliquely right rear side of the vehicle 1. The radar wave from the front center radar 12e, the front left corner radar 12f, the front right corner radar 12g, the rear left corner radar 12h, and the rear right corner radar 12i can be, for example, a millimeter wave, but is not limited thereto, and may be a microwave, an ultrasonic wave, a laser, or the like.

Furthermore, the sensor group 10 includes wheel sensors 13a and 13b, a vehicle speed sensor 14, an inertial measurement unit (IMU) 15, an operation detection unit 16, and an occupant camera 17. The wheel sensors 13a and 13b detect rotation angles of the wheels (not shown). The wheel sensors 13a and 13b may be implemented by angle sensors or may be implemented by displacement sensors. The wheel sensors 13a and 13b output detection pulses to the control device 30 each time the wheels rotate by a predetermined angle. The detection pulses output from the wheel sensors 13a and 13b can be used to calculate the rotation angles and rotation speeds of the wheels. A traveling distance of the vehicle 1 can be calculated based on the rotation angles of the wheels. The wheel sensor 13a detects, for example, a rotation angle θa of a left rear wheel. The wheel sensor 13b detects, for example, a rotation angle θb of a right rear wheel.

The vehicle speed sensor 14 detects a travel speed of the vehicle 1 (vehicle body), that is, a vehicle speed V, and outputs the detected vehicle speed V to the control device 30. The vehicle speed sensor 14 detects the vehicle speed V based on, for example, rotation of a countershaft of a transmission.

The inertial measurement device 15 detects angular velocities of the vehicle 1 in a pitch direction, a roll direction, and a yaw direction, and accelerations of the vehicle 1 in a front-rear direction, a left-right direction, and an upper-lower direction, and outputs these detection results to the control device 30. Note that an example in which the inertial measurement device 15 is provided is described in the present embodiment, but the present invention is not limited thereto. For example, merely an acceleration sensor that detects an acceleration of the vehicle 1 in a predetermined direction or a gyro sensor that detects an angular velocity of the vehicle 1 in a predetermined direction may be provided instead of the inertial measurement device 15.

The operation detection unit 16 detects an operation content performed by a user using the operation input unit 80 and outputs the detected operation content to the control device 30. The operation input unit 80 may include, for example, a blinker lever (not shown) that receives an operation to turn on a blinker as a direction indicator of the vehicle 1, and an operation button that receives an operation for setting the collision prevention control, which will be described later, to be executed or not to be executed.

The occupant camera 17 outputs to the control device 30 image data obtained by, for example, capturing an image centering on a face of an occupant sitting in a driver seat of the vehicle 1 (that is, a driver). The occupant camera 17 is an example of a driving status sensor that acquires driving status information indicating a driving status of the driver, and specifically, can function as a driving status sensor for acquiring a viewing direction, which is a direction of the face or a visual line of the driver.

The navigation device 20 detects a current position of the vehicle 1 using a global positioning system (GPS) for example, and guides a user (for example, the driver, hereinafter simply referred to as “user”) of the vehicle 1 on a route to a destination. The navigation device 20 includes a storage device (not shown) provided with a map information database.

A navigation device 20 includes a touch panel 21 and a speaker 22. The touch panel 21 functions as an input device that receives input of various kinds of information input to the control device 30 and a display device that is controlled by the control device 30. That is, the user can input various commands to the control device 30 via the touch panel 21. The touch panel 21 can display a screen for guiding and informing the user of various kinds of information. The speaker 22 outputs various kinds of information to the user by voice. That is, the touch panel 21 and the speaker 22 can function as notification devices capable of executing predetermined notification to the driver.

The control device 30 is mounted on the vehicle 1, is communicably connected to other devices mounted on the vehicle 1, and integrally controls the entire vehicle 1 by communicating with the other devices. The control device 30 is implemented by, for example, an ECU including a processor which performs various kinds of calculation, a storage device including a non-transitory storage medium which stores various kinds of information, and an input and output device which controls input and output of data between an inside and an outside of the control device 30. Note that the control device 30 may be implemented by one ECU or may be implemented by a plurality of ECUs.

Examples of the other devices connected to the control device 30 (hereinafter also simply referred to as “other devices”) include each camera, sonar group, radar, and sensor included in the sensor group 10, an EPS electronic control unit (EPSECU) 45 of the EPS system 40, a driving ECU 61 of the driving force control system 60, and a braking ECU 71 of the braking force control system 70.

Note that the EPSECU 45, the driving ECU 61, and the braking ECU 71 will be described later.

The control device 30 and the other devices are connected to each other via, for example, a wired communication network constituted by various wire harnesses, cables, connectors, and the like routed inside the vehicle 1. For example, a controller area network (CAN), a local interconnect network (LIN), Flex Ray, or a CAN with a flexible data rate (CANFD) can be adopted for the communication between the control device 30 and the other devices.

Although details will be described later, the control device 30 is configured to be capable of executing driving assistance control for assisting driving of the vehicle 1 based on the surrounding information acquired by the sensor group 10. Examples of the driving assistance control that can be executed by the control device 30 include the collision prevention control.

The collision prevention control prevents collision between the vehicle 1 and other objects (for example, moving bodies such as other vehicles), and includes, for example, notification control for notifying the driver of a possibility of collision using a predetermined notification device provided in the vehicle 1, when an object that may collide with the vehicle 1 is detected.

In the present embodiment, the notification according to the notification control is performed by displaying a predetermined warning image on the touch panel 21 and outputting a predetermined alarm sound from the speaker 22, but the present invention is not limited thereto. For example, in addition to the touch panel 21, a display device called a “multi-information display” may be provided in the vehicle 1, and the warning image may be displayed on the multi-information display to perform the notification.

The collision prevention control further includes braking control for braking the vehicle 1 when, for example, an object that may collide with the vehicle 1 is detected. In the braking control, the control device 30 decelerates or stops the vehicle 1 by, for example, instructing the braking force control system 70 (which will be described later) to generate a predetermined braking force (brake torque).

The EPS system 40 includes a steering angle sensor 41, a torque sensor 42, an EPS motor 43, a resolver 44, the EPSECU 45, and a steering touch sensor 48.

The steering angle sensor 41, the torque sensor 42, and the steering touch sensor 48 can function as driving status sensors for acquiring operations from the driver on a steering 46. Specifically, the steering angle sensor 41, the torque sensor 42, and the steering touch sensor 48 detect (acquire) a steering angle est of the steering 46, a torque TQ applied to the steering 46, and whether the driver touches the steering 46, respectively, and output the detection results to the control device 30.

For example, the EPS motor 43 can assist a steering operation of the driver by applying a driving force or a reaction force to a steering column 47 coupled to the steering 46. The resolver 44 detects a rotation angle 6m of the EPS motor 43. The EPSECU 45 controls the entire EPS system 40.

The driving force control system 60 includes the driving ECU 61. The driving force control system 60 executes driving force control of the vehicle 1. For example, the driving ECU 61 controls a driving force of the vehicle 1 by controlling an engine (not shown) or the like in response to an operation of the driver on an accelerator pedal (not shown).

The braking force control system 70 includes the braking ECU 71. The braking force control system 70 executes braking force control of the vehicle 1. The braking ECU 71 controls a braking force of the vehicle 1 by controlling a brake mechanism (not shown) or the like in response to an operation by the driver on a brake pedal (not shown).

The communication unit 50 is a communication interface that communicates with an external device 2 provided outside the vehicle 1 under control of the control device 30. That is, the control device 30 can communicate with the external device 2 via the communication unit 50. For example, a mobile communication network such as a cellular line, Wi-Fi (registered trademark), or Bluetooth (registered trademark) can be adopted for the communication between the vehicle 1 and the external device 2. The external device 2 is managed, for example, by a manufacturer of the vehicle 1. The external device 2 may be a virtual server (cloud server) implemented in cloud computing service, or may be a physical server implemented as a single device.

### Control Device

Next, an example of the control device 30 will be described in detail. As described above, the control device 30 can execute the collision prevention control for preventing collision between the vehicle 1 and other objects (for example, moving bodies such as other vehicles). Such collision prevention control can improve the safety of the vehicle 1. On the other hand, for example, even when there is a predetermined travel path boundary such as a fence between the moving bodies such as other vehicles and the vehicle 1 and it is assumed that the possibility of collision between the moving bodies and the vehicle 1 is actually low, the collision prevention control may also be executed, and the driver may feel annoyed by such collision prevention control. Therefore, in the present embodiment, execution of excessive collision prevention control, which may annoy the driver, is reduced.

The control device 30 includes a detection unit 31, a first control unit 32, and a second control unit 33 as, for example, a functional unit implemented by a processor executing a program stored in a storage device (for example, a storage unit 35 described later) of the control device 30 or a functional unit implemented by an input and output device of the control device 30. The control device 30 also includes the storage unit 35 that stores various kinds of information. The storage unit 35 includes a first storage area 35a implemented by a volatile memory such as an RAM and a second storage area 35b implemented by a nonvolatile memory such as a flash memory.

The detection unit 31 has a function of detecting a predetermined travel path boundary and a travel path region partitioned by the travel path boundary for the vehicle 1 to travel, based on the surrounding information acquired by the sensor group 10. For example, the detection unit 31 detects a partition line (for example, a lane partition line such as a white line or a yellow line) or a predetermined feature such as a fence or a plant as the travel path boundary, and detects a region partitioned by the travel path boundary as the travel path region, by image analysis on the surrounding images captured by the front camera 11a, the rear camera 11b, the left side camera 11c, and the right side camera 11d.

In this way, the control device 30 can also recognize passages not included in the map information database of the navigation device 20, such as passages in a parking lot, as the travel path region, by detecting the travel path boundary and the travel path region by the detection unit 31 based on the actually acquired surrounding information.

The first control unit 32 has a function of generating travel path information indicating positions of the detected travel path boundary and the travel path region based on a detection result of the detection unit 31. For example, when the travel path boundary or the travel path region is detected, the first control unit 32 estimates the position of the detected travel path boundary or the travel path region on a map from a positional relation between the travel path boundary or the travel path region and the vehicle 1 during that time, and generates the travel path information indicating the estimated position.

Based on the surrounding information acquired by the sensor group 10, the second control unit 33 can execute the above-described collision prevention control when a moving body such as the other vehicle is detected around the vehicle 1. Specifically, when the moving body is detected around the vehicle 1, the second control unit 33 refers to the travel path information generated by the first control unit 32, and determines whether the moving body is positioned in a target travel path region, which is the travel path region in which the vehicle 1 travels, and executes the collision prevention control based on determining that the moving body is positioned in the target travel path region. In other words, even when a moving body such as the other vehicle is detected around the vehicle 1, the second control unit 33 does not execute the collision prevention control when it is determined that the moving body is not positioned in the target travel path region. Note that the moving body around the vehicle 1 can be detected by, for example, the front center radar 12e, the front left corner radar 12f, the front right corner radar 12g, the rear left corner radar 12h, and the rear right corner radar 12i in the sensor group 10.

In this way, the collision prevention control is executed when the moving body is positioned in the target travel path region, while the collision prevention control is not executed when the moving body is positioned in a traveling region other than the target travel path region (that is, when there is a traveling boundary between the host vehicle and the moving body), so that the collision prevention control can be executed only when the possibility of collision between the vehicle 1 and the moving body is actually high. As a result, it is possible to reduce excessive collision prevention control while ensuring the safety of the vehicle 1.

### Travel Path Information Generation

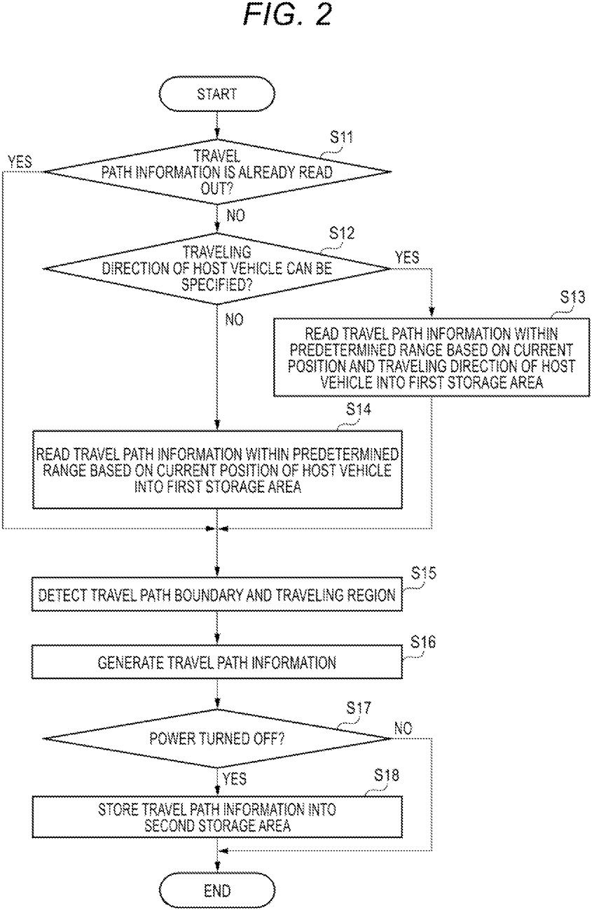

Next, regarding the generation of the travel path information, an example of the travel path information generation executed by the control device 30 will be described with reference to FIG. 2. For example, when an ignition power (hereinafter also referred to simply as “power”) of the vehicle 1 is turned on, the control device 30 repeatedly executes the travel path information generation shown in FIG. 2 at a predetermined circle.

First, the control device 30 determines whether the travel path information previously generated by the first control unit 32 is read out (step S11). Although details will be described later, the control device 30 stores the travel path information generated by the first control unit 32 when the power of the vehicle 1 is turned on in the second storage area 35b when the power of the vehicle 1 is turned off. In the processing of the step S11, the control device 30 determines whether the travel path information stored in the second storage area 35b is read into the first storage area 35a. If the travel path information is read out (step S11: Yes), the control device 30 directly proceeds to processing of a step S15.

On the other hand, if the travel path information is not read out (step S11: No), the control device 30 determines whether a traveling direction of the vehicle 1 can be specified (step S12). For example, the control device 30 determines that the traveling direction of the vehicle 1 can be specified when a shift position of the vehicle 1 is “D (drive)” or “R (reverse)”, while the control device 30 determines that the traveling direction of the vehicle 1 cannot be specified when the shift position of the vehicle 1 is “N (neutral)”. Note that when the shift position is “D”, the traveling direction of the vehicle 1 is specified to be the front side of the vehicle 1, and when the shift position is “R”, the traveling direction of the vehicle 1 is specified as the rear side of the vehicle 1. The traveling direction of the vehicle 1 may be specified based on a viewing direction of the driver (that is, a direction of face or visual line of the driver) that can be acquired by the occupant camera 17.

If the traveling direction of the vehicle 1 can be specified (step S12: Yes), the control device 30 reads the travel path information within a predetermined range based on a current position and the traveling direction of the vehicle 1 from the second storage area 35b to the first storage area 35a (step S13). For example, when the traveling direction of the vehicle 1 is specified as the front side, in the processing of the step S13, the control device 30 reads out the travel path information of a part in the front side of the vehicle 1 within a range with a radius of 100 [m] centered on the vehicle 1. When the traveling direction of the vehicle 1 is specified as the rear side, in the processing of the step S13, the control device 30 reads out the travel path information of a part in the rear side of the vehicle 1 within a range with a radius of 100 [m] centered on the vehicle 1. Note that the current position of the vehicle 1 can be acquired from the navigation device 20 or the like.

On the other hand, if the traveling direction of the vehicle 1 cannot be specified (step S12: No), the control device 30 reads the travel path information within a predetermined range based on the current position of the vehicle 1 from the second storage area 35b to the first storage area 35a (step S14). For example, in the processing of the step S14, the control device 30 reads the travel path information within a range with a radius of 100 [m] centered on the vehicle 1. Note that the predetermined range, which is a condition for the travel path information read out by the processing in the steps S13 and S14, is not limited to the above examples, and may be appropriately determined by a manufacturer of the vehicle 1 or the like.

By the processing of the steps S11 to S14, the control device 30 reads the travel path information generated by the first control unit 32 and stored in the second storage area 35b to the first storage area 35a when the power of the vehicle 1 is turned on.

The control device 30 reads out only the travel path information within the predetermined range based on the current position of the vehicle 1 in the travel path information stored in the second storage area 35b into the first storage area 35a. Therefore, compared with a case where all the travel path information stored in the second storage area 35b is read out, it is possible to reduce a time required to read out the travel path information and a capacity of the first storage area 35a required to hold the read out travel path information. Moreover, the control device 30 reads out only the travel path information within the predetermined range based on the current position and the traveling direction of the vehicle 1 in the travel path information stored in the second storage area 35b into the first storage area 35a, and therefore, it is possible to further reduce the time required to read out the travel path information and the capacity of the first storage area 35a required to hold the read out travel path information.

Next, the control device 30 detects the travel path boundary and the traveling region by the detection unit 31 (step S15), and generates the travel path information by the first control unit 32 (step S16). In this case, the first control unit 32 generates the travel path information while using the first storage area 35a as a work area.

Next, the control device 30 determines whether the power of the vehicle 1 is turned off (step S17). If the power of the vehicle 1 is not turned off (step S17: No), the control device 30 directly ends the current travel path information generation. On the other hand, when the power of the vehicle 1 is turned off (step S17: Yes), the control device 30 ends the generation of the travel path information and stores the travel path information generated in the first storage area 35a in the second storage area 35b (step S18), and ends the current travel path information generation.

As described above, the control device 30 (for example, the first control unit 32) starts generating the travel path information when the power of the vehicle 1 is turned on, and ends generating the travel path information when the power of the vehicle 1 is turned off, and can store the generated travel path information in the second storage area 35b of the storage unit 35. Then, the control device 30 (for example, the second control unit 33) reads the travel path information stored in the second storage area 35b as described above into the first storage area 35a when the power of the vehicle 1 is turned on.

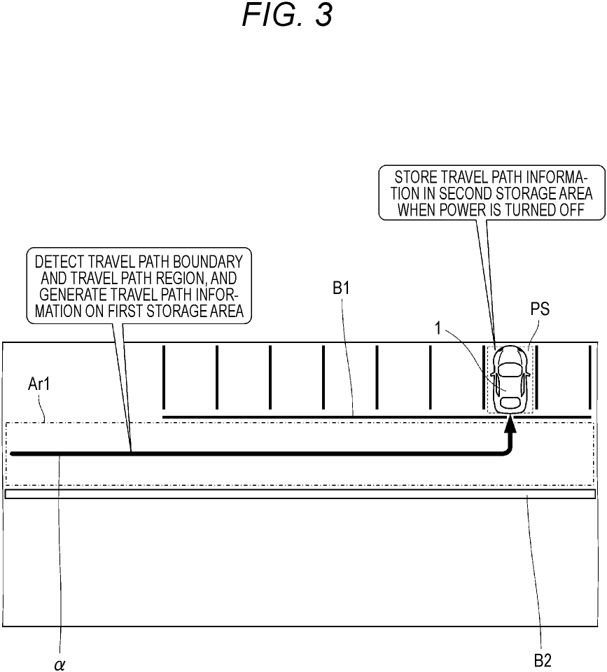

FIG. 3 is a diagram showing an operation example of the vehicle 1 that can be implemented by the travel path information generation shown in FIG. 2. FIG. 3 shows an example in which the vehicle 1 is parked in a parking space PS after traveling along a route indicated by an arrow a, and the power is turned off in the parking space PS.

In the example shown in FIG. 3, when the vehicle 1 travels along the route indicated by the arrow α, the control device 30 detects a travel path boundary B1, which is a partition line, and a travel path boundary B2, which is a fence made of a wire mesh or the like, and a first travel path region Ar1 partitioned by the travel path boundary B1 and the travel path boundary B2. In this case, when the vehicle 1 travels along the route indicated by the arrow α, the travel path information indicating the positions of the travel path boundary B1, the travel path boundary B2, and the first travel path region Ar1 on the map is generated in the first storage area 35a.

Then, the vehicle 1 traveling along the route indicated by the arrow a is parked in the parking space PS and the power is turned off in the parking space PS. During this time, the control device 30 stores, in the nonvolatile second storage area 35b, the travel path information generated in the first storage area 35a when the vehicle 1 travels along the route indicated by the arrow α As a result, it is possible to hold the travel path information generated when the vehicle 1 travels along the route indicated by the arrow α so that the travel path information can be used even after the power of the vehicle 1 is turned off.

Then, when the power of the vehicle 1 is turned on when, for example, starting from the parking space PS, the control device 30 reads out the travel path information stored in the second storage area 35b. In this case, the read out travel path information includes, for example, the travel path information generated when the vehicle 1 travels along the route indicated by the arrow α.

### Collision Prevention Control

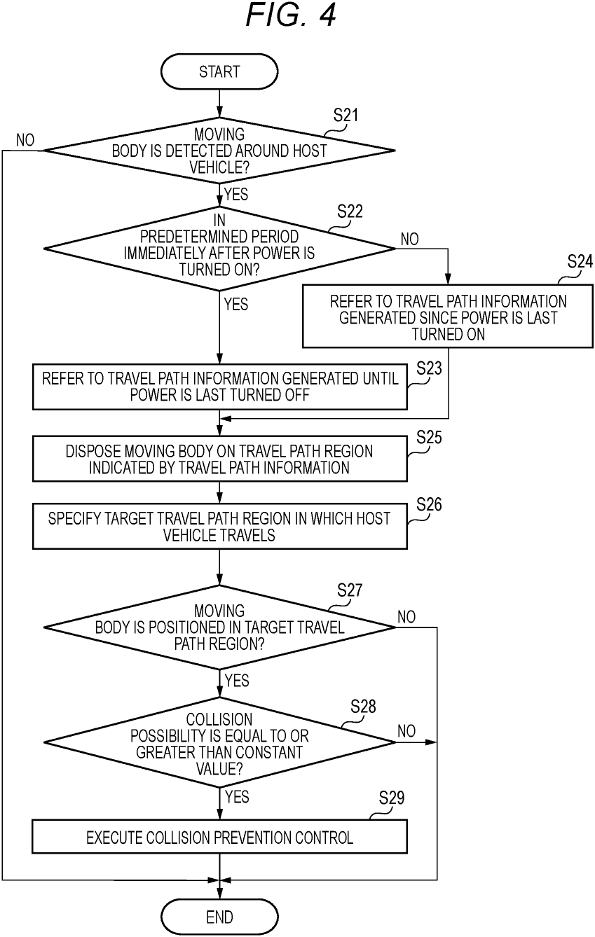

Next, regarding the collision prevention control, an example of the collision prevention control executed by the control device 30 will be described with reference to FIG. 4. For example, when the power of the vehicle 1 is turned on, the control device 30 repeatedly executes the collision prevention control shown in FIG. 4 at a predetermined circle.

First, the control device 30 determines whether a moving body is detected around the vehicle 1 based on the surrounding information acquired by the sensor group 10 (step S21). Examples of the moving body include other vehicles and pedestrians. If no moving body is detected (step S21: No), the control device 30 directly ends the current collision prevention control.

On the other hand, when a moving body is detected (step S21: Yes), the control device 30 determines whether the current time is within a predetermined period immediately after the power of the vehicle 1 is turned on (step S22). This predetermined period may be, for example, a period from when the power is turned on until the vehicle 1 travels a predetermined distance (for example, 100 [m]), or a period from when the power is turned on until a predetermined time (for example, 1 minute) elapses. This predetermined period can be appropriately determined by the manufacturer of the vehicle 1 or the like.

Within the predetermined period immediately after the power is turned on (step S22: Yes), the control device 30 takes the travel path information generated until the power is last turned off as a reference target (step S23). In this case, the travel path information taken as the reference target is, for example, the travel path information read into the first storage area 35a by the processing of the step S13 or the step S14.

In other words, the travel path information sufficient for properly determining whether to execute the collision prevention control may not be generated from when the power of the vehicle 1 is turned on until the predetermined period elapses. According to the processing of the step S23, it is possible to determine whether to execute the collision prevention control in the predetermined period immediately after the power of the vehicle 1 is turned on by referring to the previously generated travel path information. As a result, it is possible to appropriately determine whether to execute the collision prevention control immediately after the power of the vehicle 1 is turned on.

On the other hand, if the current time is not within the predetermined period after the power of the vehicle 1 is turned on, that is, if the predetermined period elapses (step S22: No), the control device 30 takes the travel path information generated since the power is last (most recently) turned on as the reference target (step S24).

In other words, it is highly probable that the travel path information sufficient for properly determining whether to execute the collision prevention control is generated from when the power of the vehicle 1 is turned on until the predetermined period elapses. According to the processing of the step S24, after the predetermined period elapses from the power of the vehicle 1 is turned on, it is possible to determine whether to execute the collision prevention control by referring to the travel path information generated since the power is last turned on (that is, the latest travel path information). As a result, after the predetermined period elapses from the power of the vehicle 1 is turned on, it is possible to determine whether to execute the collision prevention control based on the travel path information more relevant to current conditions.

Then, the control device 30 disposes the detected moving body on the travel path region indicated by the travel path information taken as the reference target (step S25). In the processing of the step S25, for example, the control device 30 first estimates the position of the moving body on the map from the detected positional relation between the moving body and the vehicle 1. Then, the control device 30 refers to the estimated position of the moving body on the map and the position of each travel path region indicated by the travel path information taken as the reference target on the map, and disposes the moving body on the map in the travel path region in which the moving body is estimated to move.

Next, the control device 30 specifies the target travel path region, which is a travel path region in which the vehicle 1 travels, based on the current position and the traveling direction of the vehicle 1 (step S26). For example, when the vehicle 1 is positioned in any one travel path region of the travel path regions included in the travel path information taken as the reference target, the control device 30 specifies the travel path region in which the vehicle 1 is positioned as the target travel path region. When the vehicle 1 is not positioned in any travel path region, such as when the vehicle 1 is positioned in the parking space PS described above, the control device 30 specifies the travel path region positioned in the traveling direction of the vehicle 1 and closest to the vehicle 1 of the travel path regions included in the travel path information taken as the reference target, as the target travel path region.

Next, the control device 30 compares the travel path region in which the moving body is disposed by the processing of the step S25 with the target travel path region specified by the processing of the step S26, and then determines whether the moving body is positioned in the target travel path region (step S27). If the moving body is not positioned in the target travel path region (step S27: No), that is, if the moving body moves on a travel path region different from that of the vehicle 1, it is assumed that the possibility of collision between the moving body and the vehicle 1 is actually low regardless of the distance between the moving body and the vehicle 1 or the like, so that the control device 30 directly ends the current collision prevention control.

On the other hand, if the moving body is positioned in the target travel path region (step S27: Yes), the control device 30 determines whether a collision possibility representing the possibility of collision between the moving body and the vehicle 1 is equal to or greater than a constant value (step S28). In the processing of the step S28, for example, when the distance between the moving body and the vehicle 1 or a time to collision (TTC) obtained by dividing this distance by a relative speed between the moving body and the vehicle 1 is equal to or less than a predetermined threshold, the control device 30 determines that the collision possibility is equal to or greater than the constant value.

If the collision possibility is less than the constant value (step S28: No), although the moving body moves in the same travel path region as the vehicle 1, but the possibility of collision between the moving body and the vehicle 1 is assumed to be low, and therefore, the control device 30 directly ends the current collision prevention control. On the other hand, if the collision possibility is equal to or greater than the constant value (step S28: Yes), there is a risk of collision between the moving body and the vehicle 1, and therefore, the control device 30 executes the collision prevention control (step S29) and then ends the collision prevention control.

As described above, the control device 30 (for example, the second control unit 33) detects a moving body around the vehicle 1 and only when the moving body is positioned in the target travel path region, executes the collision prevention control. In other words, even if a moving body is detected around the vehicle 1, the control device 30 does not execute the collision prevention control when it is assumed that the moving body is not positioned in the target travel path region, that is, the moving body moves on a travel path region different from that of the vehicle 1, and there is some traveling boundary between the vehicle 1 and the moving body. As a result, the collision prevention control can be executed only when the possibility of actual collision between the vehicle 1 and the moving body is high, and it is possible to reduce excessive collision prevention control while ensuring the safety of the vehicle 1.

Note that the control device 30 may execute the collision prevention control under an additional condition that an operation to start the vehicle 1, such as an operation to depress an accelerator pedal or an operation to loosen a brake pedal, is performed. That is, the control device 30 (for example, the second control unit 33) may execute the collision prevention control only when a moving body is detected around the vehicle 1, and the moving body is positioned in the target travel path region, and an operation to start the vehicle 1 is performed. In this way, it is possible to prevent the collision prevention control from being executed even if the vehicle 1 is not about to start, and to further reduce excessive collision prevention control.

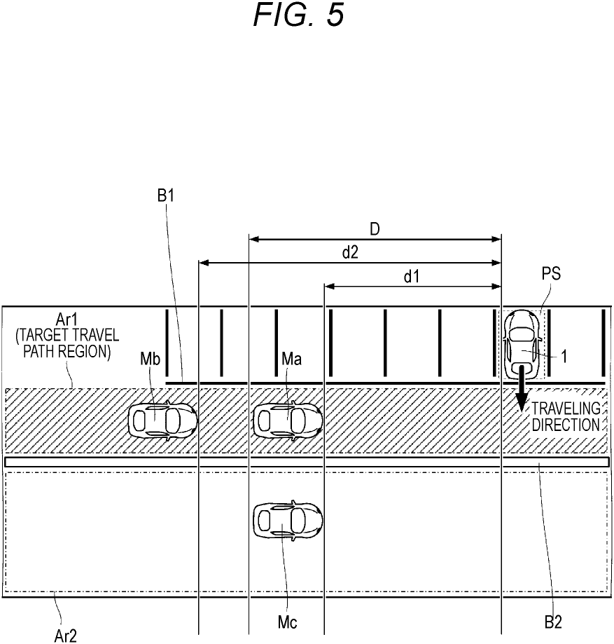

FIG. 5 is a diagram showing an operation example of the vehicle 1 that can be implemented by the collision prevention control shown in FIG. 4. FIG. 5 shows an operation example of the vehicle 1, which is a continuation of the operation example shown in FIG. 3.

The driver who parks the vehicle 1 in the parking space PS turns on the power of the vehicle 1 when starting the vehicle 1 from the parking space PS. When the power of the vehicle 1 is turned on, the control device 30 reads out the travel path information stored in the second storage area 35b. In this case, the read out travel path information includes, for example, the travel path information generated when the vehicle 1 travels along the route indicated by the arrow α.

During this time, for example, the other vehicle Ma is detected around the vehicle 1. Here, the other vehicle Ma is a vehicle that is positioned in the first travel path region Ar1, which is the target travel path region, and that is at a distance d1 from the vehicle 1. Here, d1 is a distance equal to or less than a distance D which is used as the threshold used as a condition for determining that the collision possibility is equal to or greater than the constant value. According to the collision prevention control shown in FIG. 4, the control device 30 can execute the collision prevention control when such the other vehicle Ma is detected to prevent the vehicle 1 from colliding with the other vehicle Ma.

On the other hand, instead of the other vehicle Ma, for example, the other vehicle Mb is detected around the vehicle 1. Here, the other vehicle Mb is a vehicle that is positioned in the first travel path region Arl, which is the target travel path region, and that is at a distance d2 from the vehicle 1. Here, d2 is a distance greater than the distance D. By the collision prevention control shown in FIG. 4, the control device 30 can prevent the collision prevention control from being executed even if such the other vehicle Mb is detected.

On the other hand, instead of the other vehicle Ma, for example, the other vehicle Mc is detected around the vehicle 1. Here, the other vehicle Mc is a vehicle whose distance from the vehicle 1 is equal to or less than the distance D, but which is positioned in the second travel path region Ar2 different from the first travel path region Ar1 that is the target travel path region. By the collision prevention control shown in FIG. 4, the control device 30 can prevent the collision prevention control from being executed even if such the other vehicle Mc is detected.

### Specific Example of Collision Prevention Control

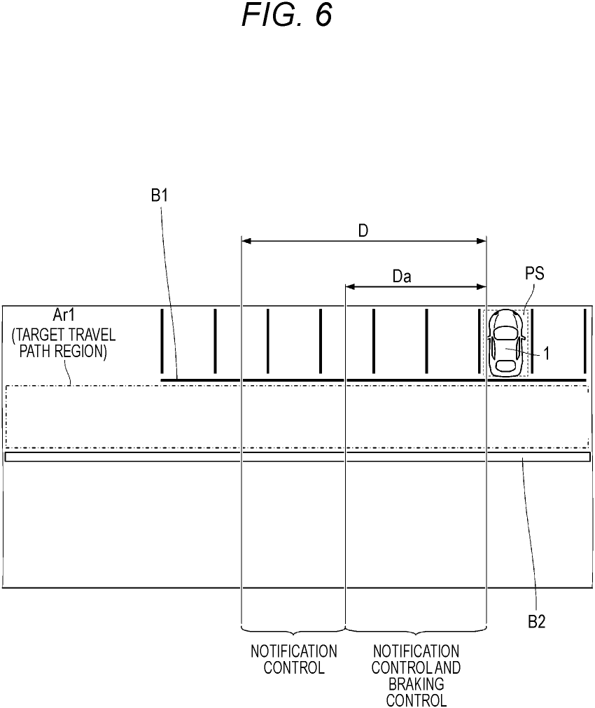

Next, a specific example of the collision prevention control will be described with reference to FIG. 6. When a moving body positioned in the first travel path region Ar1, which is the target travel path region, and whose distance from the vehicle 1 is euqal to or less than the distance D, such as the other vehicle Ma shown in FIG. 5, is detected, the control device 30 (for example, the second control unit 33) preferably executes the collision prevention control in different control modes depending on the possibility of collision between the moving body and vehicle 1. In this way, it is possible to execute the collision prevention control in an appropriate control mode according to the possibility of collision between the vehicle 1 and the moving body.

As a specific example, when the distance between the vehicle 1 and the moving body positioned in the first travel path region Ar1, which is the target travel path region, is equal to or less than the distance D and equal to or greater than a distance Da (here, D > Da > 0), the control device 30 executes only the notification control between the notification control and the braking control of the collision prevention control. On the other hand, when the distance between the vehicle 1 and the moving body positioned in the first travel path region Ar1, which is the target travel path region, is less than the distance Da, the control device 30 executes the notification control and the braking control of the collision prevention control. Note that the distance Da can be appropriately determined by the manufacturer of the vehicle 1 or the like.

As described above, when the moving body is detected around the vehicle 1, the control device 30 (for example, the second control unit 33) can refer to the travel path information generated by the first control unit 32, and determine whether the moving body is positioned in the target travel path region, which is the travel path region in which the vehicle 1 travels, and execute the collision prevention control based on determining that the moving body is positioned in the target travel path region. As a result, when the possibility of collision between the vehicle 1 and the moving body is high, the collision prevention control is executed, and when the possibility of collision between the vehicle 1 and the moving body is low, the collision prevention control can be prevented from being executed. Therefore, it is possible to reduce excessive collision prevention control while ensuring the safety of the vehicle 1.

The control device 30 (the first control unit 32) starts generating the travel path information when the power of the vehicle 1 is turned on, and ends generating the travel path information when the power of the vehicle is turned off, and can store the generated travel path information in the storage unit 35 (for example, the second storage area 35b). Then, in a predetermined period immediately after the power of the vehicle 1 is turned on, the control device 30 (for example, the second control unit 33) can determine whether the moving body is positioned in the target travel path region by referring to the travel path information stored in the storage unit 35 (for example, the second storage area 35b). As a result, since in the predetermined period immediately after the power of the vehicle 1 is turned on, whether to execute the collision prevention control is determined by referring to the travel path information previously stored in the storage unit 35, it is possible to appropriately determine whether to execute the collision prevention control immediately after the power of the vehicle 1 is turned on.

After a predetermined period elapses from the power of the vehicle 1 is turned on, the control device 30 (the second control unit 33) can determine whether the moving body is positioned in the target travel path region by referring to the travel path information generated since the power of the vehicle 1 is turned on. As a result, after the predetermined period elapses from the power of the vehicle 1 is turned on, it is possible to determine whether to execute the collision prevention control based on the travel path information more relevant to the current conditions.

The storage unit 35 includes the first storage area 35a implemented by a volatile memory and the second storage area 35b implemented by a nonvolatile memory, and the control device 30 (for example, the first control unit 32) can store the generated travel path information in the second storage area 35b when the power of the vehicle 1 is turned off. Then, the control device 30 can read the travel path information stored in the second storage area 35b into the first storage area 35a when the power of the vehicle 1 is turned on. Furthermore, in a predetermined period immediately after the power of the vehicle 1 is turned on, the control device 30 (for example, the second control unit 33) can determine whether the moving body is positioned in the target travel path region by referring to the travel path information read into the first storage area 35a as described above. In general, the second storage area 35b implemented by a nonvolatile memory is inferior in access speed to the first storage area 35a implemented by a volatile memory. By reading the travel path information stored in the second storage area 35b into the first storage area 35a when the power of the vehicle 1 is turned on, it is possible to quickly determine whether to execute the collision prevention control with reference to the travel path information.

From the travel path information stored in the second storage area 35b, the control device 30 reads into the first storage area 35a the travel path information indicating the positions of the travel path boundary and the travel path region within a predetermined range based on the current position of the vehicle 1. As a result, it is possible to reduce the time required to read the travel path information into the first storage area 35a and the capacity of the first storage area 35a required to hold the travel path information.

From the travel path information stored in the second storage area 35b, the control device 30 reads into the first storage area 35a the travel path information indicating the positions of the travel path boundary and the travel path region within a predetermined range based on the current position of the vehicle 1 and the traveling direction of the vehicle 1. As a result, it is possible to further reduce the time required to read the travel path information into the first storage area 35a and the capacity of the first storage area 35a required to hold the travel path information.

The control device 30 (for example, the second control unit 33) specifies the target travel path region based on the current position and the traveling direction of the vehicle 1, and determines whether the moving body is positioned in the specified target travel path region. In this way, it is possible to specify the target travel path region without requiring any operation or the like for specifying the target travel path region.

The control device 30 (for example, the second control unit 33) can execute the collision prevention control when the moving body is positioned in the target travel path region and the possibility of collision between the vehicle 1 and the moving body is equal to or greater than the constant value. In this way, it is possible to further reduce excessive collision prevention control when the possibility of collision between the vehicle 1 and the moving body is low.

When the possibility of collision between the vehicle 1 and the moving body is equal to or greater than the constant value, the control device 30 (for example, the second control unit 33) can execute the collision prevention control in different control modes depending on the possibility. Therefore, it is possible to execute the collision prevention control in an appropriate control mode according to the possibility of collision between the vehicle 1 and the moving body.

Although an embodiment of the present invention has been described above with reference to the drawings, it is needless to say that the present invention is not limited to the above-described embodiment. It will be apparent to those skilled in the art that various changes and modifications may be conceived within the scope of claims. It is also understood that the various changes and modifications belong to the technical scope of the present invention. The respective constituent elements in the above embodiments may be combined as desired without departing from the gist of the invention.

For example, when the travel path information is stored in the second storage area 35b, a date during that time and the travel path information are stored in association with each other, and it is preferable to delete the travel path information, from whose storage time a certain period (for example, one year) elapses, from the second storage area 35b. As a result, the capacity of the second storage area 35b for storing the travel path information can be reduced, and it is possible to avoid determining whether to execute the collision prevention control by referring to old travel path information (travel path information that may not be relevant to the current conditions).

Although forms of carrying out the present invention have been described above using the embodiments, the present invention is by no means limited to these embodiments, and various modifications and substitutions can be made without departing from the scope of the present invention.

At least the following matters are described in the present description. Components corresponding to those according to the embodiments described above are shown in parentheses. However, the present invention is not limited thereto.

(1) A control device (control device 30) for controlling a vehicle (vehicle 1) equipped with an external sensor (sensor group 10) that acquires surrounding information of the vehicle, the control device including:
a detection unit (detection unit 31) that detects a predetermined travel path boundary (travel path boundary B1, travel path boundary B2) and a travel path region (first travel path region Ar1, second travel path region Ar2) for the vehicle to travel partitioned by the travel path boundary, based on the surrounding information acquired by the external sensor;
a first control unit (first control unit 32) that generates travel path information indicating positions of the detected travel path boundary and the travel path region based on a detection result of the detection unit; and
a second control unit (second control unit 33) capable of executing collision prevention control that prevents collision between the vehicle and a moving body (the other vehicle Ma, Mb, or Mc) when the moving body is detected around the vehicle based on the surrounding information, in which
when the moving body is detected, the second control unit refers to the travel path information generated by the first control unit, and determines whether the moving body is positioned in a target travel path region in which the vehicle travels, and executes the collision prevention control based on determination that the moving body is positioned in the target travel path region.

According to (1), the collision prevention control is executed when the moving body is positioned in the target travel path region, while the collision prevention control can be prevented from being executed when the moving body is positioned in a traveling region other than the target travel path region (that is, when there is a traveling boundary between the vehicle and the moving body). As a result, when the possibility of collision between the vehicle and the moving body is high, the collision prevention control is executed, and when the possibility of collision between the vehicle and the moving body is low, the collision prevention control can be prevented from being executed, and therefore, it is possible to reduce excessive collision prevention control.

(2) The control device according to (1), in which
the first control unit starts generating the travel path information when a power of the vehicle is turned on, and ends generating the travel path information and stores the generated travel path information in a storage unit (storage unit 35) when the power of the vehicle is turned off, and
the second control unit refers to the travel path information stored in the storage unit for a predetermined period immediately after the power of the vehicle is turned on.

The travel path information sufficient for properly determining whether to execute the collision prevention control may not be generated from when the power of the vehicle is turned on until the predetermined period elapses. According to (2), since in the predetermined period immediately after the power of the vehicle is turned on, whether to execute the collision prevention control is determined by referring to the travel path information previously stored in the storage unit, it is possible to appropriately determine whether to execute the collision prevention control immediately after the power of the vehicle is turned on.

(3) The control device according to (2), in which

the second control unit refers to the travel path information generated since the power of the vehicle is turned on, after the predetermined period elapses from the power of the vehicle is turned on.

It is highly probable that the travel path information sufficient for determining whether to execute the collision prevention control is generated from when the power of the vehicle is turned on until the predetermined period elapses. According to (3), after the predetermined period elapses from the power of the vehicle is turned on, whether to execute the collision prevention control is determined by referring to the travel path information generated from when the power of the vehicle is turned on, and therefore, it is possible to determine whether to execute the collision prevention control based on the travel path information more relevant to the current conditions after the predetermined period elapses.

(4) The control device according to (2) or (3), in which
the storage unit includes a first storage area (first storage area 35a) implemented by a volatile memory and a second storage area (second storage area 35b) implemented by a nonvolatile memory,
the first control unit stores the generated travel path information in the second storage area when the power of the vehicle is turned off,
the control device reads the travel path information stored in the second storage area into the first storage area when the power of the vehicle is turned on, and
the second control unit refers to the travel path information read into the first storage area during the predetermined period.

In general, the second storage area implemented by a nonvolatile memory is inferior in access speed to the first storage area implemented by a volatile memory. According to (4), since the travel path information stored in the second storage area is read into the first storage area when the power of the vehicle is turned on, it is possible to quickly determine whether to execute the collision prevention control with reference to the travel path information.

(5) The control device according to (4), in which

from the travel path information stored in the second storage area, the control device reads into the first storage area travel path information indicating the positions of the travel path boundary and the travel path region within a predetermined range based on a current position of the vehicle.

According to (5), it is possible to reduce the time required to read the travel path information into the first storage area and the capacity of the first storage area required to hold the travel path information.

(6) The control device according to (5), in which

from the travel path information stored in the second storage area, the control device reads into the first storage area travel path information indicating the positions of the travel path boundary and the travel path region within the predetermined range based on the current position and a traveling direction of the vehicle.

According to (6), it is possible to reduce the time required to read the travel path information into the first storage area and the capacity of the first storage area required to hold the travel path information.

(7) The control device according to any one of (1) to (6), in which

the second control unit specifies the target travel path region based on the current position and the traveling direction of the vehicle, and determines whether the moving body is positioned in the specified target travel path region.

According to (7), it is possible to specify the target travel path region without requiring any operation or the like for specifying the target travel path region.

(8) The control device according to any one of (1) to (7), in which

the second control unit executes the collision prevention control when the moving body is positioned in the target travel path region and a possibility of collision between the vehicle and the moving body is equal to or greater than a constant value.

According to (8), it is possible to further reduce excessive collision prevention control when the possibility of collision between the vehicle and the moving body is low.

(9) The control device according to (8), in which

the second control unit executes the collision prevention control in different control modes depending on the possibility, when the possibility is equal to or greater than the constant value.

According to (9), it is possible to execute the collision prevention control in an appropriate control mode according to the possibility of collision between the vehicle and the moving body.

What is claimed is:

1. A control device for controlling a vehicle equipped with an external sensor that acquires surrounding information of the vehicle, the control device comprising processing circuitry configured to:
detect a predetermined travel path boundary and a travel path region for the vehicle to travel partitioned by the travel path boundary, based on the surrounding information acquired by the external sensor; and
generate travel path information indicating positions of the detected travel path boundary and the travel path region based on a detection result of the detection unit, and
capable of executing collision prevention control that prevents collision between the vehicle and a moving body when the moving body is detected around the vehicle based on the surrounding information, wherein
when the moving body is detected, the processing circuitry refers to the travel path information, and determines whether the moving body is positioned in a target travel path region in which the vehicle travels, and executes the collision prevention control based on determination that the moving body is positioned in the target travel path region.

2. The control device according to claim 1, wherein
the processing circuitry starts generating the travel path information when a power of the vehicle is turned on, and ends generating the travel path information and stores the generated travel path information in a storage unit when the power of the vehicle is turned off, and
the processing circuitry refers to the travel path information stored in the storage unit for a predetermined period immediately after the power of the vehicle is turned on.

3. The control device according to claim 2, wherein
the processing circuitry refers to the travel path information generated since the power of the vehicle is turned on, after the predetermined period elapses from the power of the vehicle is turned on.

4. The control device according to claim 2, wherein
the storage unit includes a first storage area implemented by a volatile memory and a second storage area implemented by a nonvolatile memory,
the processing circuitry stores the generated travel path information in the second storage area when the power of the vehicle is turned off,
the control device reads the travel path information stored in the second storage area into the first storage area when the power of the vehicle is turned on, and
the processing circuitry refers to the travel path information read into the first storage area during the predetermined period.

5. The control device according to claim 4, wherein
from the travel path information stored in the second storage area, the control device reads into the first storage area travel path information indicating the positions of the travel path boundary and the travel path region within a predetermined range based on a current position of the vehicle.

6. The control device according to claim 5, wherein
from the travel path information stored in the second storage area, the control device reads into the first storage area travel path information indicating the positions of the travel path boundary and the travel path region within the predetermined range based on the current position and a traveling direction of the vehicle.

7. The control device according to claim 1, wherein
the processing circuitry specifies the target travel path region based on the current position and the traveling direction of the vehicle, and determines whether the moving body is positioned in the specified target travel path region.

8. The control device according to claim 1, wherein
the processing circuitry executes the collision prevention control when the moving body is positioned in the target travel path region and a possibility of collision between the vehicle and the moving body is equal to or greater than a constant value.

9. The control device according to claim 8, wherein
the processing circuitry executes the collision prevention control in different control modes depending on the possibility, when the possibility is equal to or greater than the constant value.
